(19) United States
(12) Patent Application Publication
(10) Pub. No.: US 2013/0218583 A1
(43) Pub. Date: Aug. 22, 2013

(54) Electronic Patient Monitoring System and Method

(71) Applicant: Invisalert Solutions, LLC, (US)

(72) Inventors: Michele Marcolongo, Aston, PA (US); Regina Widdows, Ivyland, PA (US)

(73) Assignee: Invisalert Solutions, LLC, Philadelphia, PA (US)

(21) Appl. No.: 13/735,715

(22) Filed: Jan. 7, 2013

Related U.S. Application Data
(60) Provisional application No. 61/583,373, filed on Jan. 5, 2012.

(51) Int. Cl. G06F 19/00

(52) U.S. Cl. CPC G06F 19/3406
USPC 705/2

(57) ABSTRACT

An electronic patient monitoring system that includes a not easily removable patient identification and monitoring device, an observer transmitter/receiver device to communicate with the not easily removable patient identification and monitoring device when within a specified visual range of each other within a predefined time interval, and a central computer system including, at least, a computer processor, communications components and system software to communicate with the observer transmitter/receiver device at specified/predetermined time intervals to receive observer- and patient-specific information.

### FIELD OF THE INVENTION

The invention is in the field of patient monitoring systems to ensure patient safety. The invention more particularly relates to patient monitoring systems that require one or more assigned facility staff members to actively monitor, i.e., directly observe, patients under their care at specific time intervals to ensure the patients are engaging in safe behaviors and participating in the therapeutic milieu.

### BACKGROUND OF THE INVENTION

Individuals are often in need of secure placement in a healthcare facility to ensure that their safety and the safety of others within the community will be maintained. When an individual is unable to care for him/herself due to physical or mental disability or, for example, the individual is unable to commit to maintain his/her own safety, or has made an attempt to end his/her life, inpatient psychiatric care is suggested. Although the description below relates to psychiatric care, the system and method are equally applicable to patients without psychiatric issues, but with physical issues.

Inpatient psychiatric care is appropriate for individuals who are voicing suicidal ideation and have expressed a specific and feasible plan as to how they may successfully complete a suicide attempt. Likewise, inpatient care is appropriate for individuals who have recently attempted suicide or made a serious suicidal gesture. Inpatient care is the appropriate course of treatment for individuals who are voicing homicidal ideation, precipitated by a diagnosed psychiatric condition or as specified by an outpatient physician according to his/her diagnosis and treatment strategy. Inpatient psychiatric care may also be appropriate for individuals who are unable to refrain from self-harm such as excessive cutting behaviors or self-mutilation. Inpatient psychiatric care is appropriate for individuals who are unable to care for themselves due to a diagnosed psychiatric disorder which interferes with their ability to function effectively.

Inpatient psychiatric care typically consists of a free standing or hospital affiliated facility that is dedicated to the treatment of a primary psychiatric disorder. Inpatient psychiatric facilities consist of locked, secured units which may serve a general adult population or be specialized to a specific patient demographic such as adolescent, older adult, or patients with a dual diagnosis which would include a psychiatric diagnosis concurrent with a substance abuse issue.

Inpatient units are locked facilities and patients do not have free access to enter or leave the unit and do not have access to some restricted areas on the unit. The inpatient unit environment is a secured setting where careful consideration has been taken to ensure most potentially hazardous environmental objects have been removed. Obvious objects of risk have been removed to lessen the potential for patients harming themselves. Upon entering an inpatient facility all patient belongings are examined for items that could be potentially harmful. Any sharp or potentially harmful items are confiscated and placed in a secure area for use with direct staff supervision.

The physical environment of the unit has been adapted to ensure maximum safety for the patients and staff. Shower rods and shower heads do not bear weight, light fixtures are recessed, cameras monitor common areas throughout the unit.

Despite these adaptations, certain risk factors are inherent in the configuration of any inpatient psychiatric unit, and it would be impossible and inhumane to remove any and all potentially harmful items.

Given this inherent risk and the need to ensure patient safety, inpatient psychiatric units closely observe all patients at specified time intervals. The specified observation period is determined by qualified mental health professionals and may be modified dependent on the risk factors that the patient is exhibiting. The highest level of observation would be a 1:1 observation status with a staff person assigned to monitor the patient's activities. The staff person typically needs to be within arm's length of the patient and is not permitted to be assigned any other unit responsibilities. The next level of observation is an eyesight status, wherein the staff member needs to maintain visual contact at all times to monitor all of a patient's activities.

As used herein, “Visual Observation” is defined as the observation made by an observer visually to determine the activity of the patient; and “Line-of-Sight” is defined as an electronic connection from the observer to the patient which, generally, is effectively made without obstacles in the path of the signal.

Excluding these higher levels of continuous observation, all other observation checks relate to specified time intervals. The attending physician, or other qualified mental health professional, predetermines what specified time period would best suit the patient's needs for safety. This specified time interval is shared with the unit staff member(s) that are responsible for monitoring the patients. The specified time interval for the observation check to ensure patient safety may be visually observed every 15 minutes, 30 minutes, 1 hour, etc. depending on the clinical needs of the specific patient.

When completing an observation check for a patient, a staff member is required to make rounds on the unit to ensure that the patients assigned to their care are engaged in safe behaviors. The staff member is required to personally witness, through a visual observation what each patient is doing (e.g., attending group therapy, sleeping, etc.), and document that this observation check was completed.

Currently, these observation checks are manually documented by unit staff member(s), who document this information on a clipboard that holds the paper observation checklist. This observation checklist specifies where the patient is on the unit, and includes the initials of the staff member that verified the patient(s) was/were visually observed for engagement in safe behavior at the specified time interval.

The current system presents many opportunities for human error, which welcomes risk for patient safety. With the current system, the unit observation clipboard may have numerous (for example 15, 25 or more) separate observation documents. There may be numerous different observers assigned to a psychiatric unit at one time, depending on the size of the unit as well as the observer to patient ratios specified by the facility. It is very challenging for staff to accurately ensure that each patient has been appropriately monitored without repeatedly assessing all of these paper documents.

With the current system, it is possible to incorrectly identify patients. A staff member may observe patients who are attending a group therapy session. By glancing in the group therapy room, a staff person may make the assumption that all of the patients on the unit are in attendance, when in fact one or more patients may have excused themselves from the group and may be engaged in unsafe behaviors.

In addition, staff may be unsure of each patient's name on a unit. On a unit with numerous patients it is difficult for a staff person coming on duty to verify each individual's name, and match it to the specific observation checklist specific to that patient on the clipboard. Errors often occur when a staff member makes an assumption based on patient demographics (e.g., age, sex, name, room number, etc.) versus primary verification methods (e.g., checking wristband).

The current system allows the potential for documentation that all patients on the unit had been visually observed as scheduled, when in fact, an observation check may have been missed. In theory, staff could be non-conformant with protocol by documenting that all visual observations had been completed, on schedule, without leaving the nurses' station, or without being on the unit and performing the required visual assessment.

Unfortunately, with the current system, when a visual observation check is missed or erroneously recorded there is no mechanism to alert the staff member or unit personnel that the observation check was missed or incorrect. Typically, a missed or undocumented observation is discovered after the fact, upon review of the paper documentation, or upon discovery of an adverse patient event. The charge nurse or unit manager would not be immediately aware that visual observation checks were being missed as there is no mechanism for real time notification.

### BRIEF DESCRIPTION OF THE DRAWINGS

Non-limiting and non-exhaustive embodiments of the present invention are described with reference to the following figures, wherein like reference numerals and/or indicia refer to like parts throughout the various views unless otherwise precisely specified.

FIG. 1a is a block diagram of an electronic monitoring system using visual observation and RF signals, in accordance with an embodiment of the present invention.

FIG. 1b is a block diagram of an electronic monitoring system using line of sight and infrared and/or laser, in accordance with an embodiment of the present invention.

FIG. 2 is a plan view of an exemplary floor plan of a facility in which an electronic monitoring system has been installed, in accordance with one or more embodiments of the present invention.

FIG. 3a is a flow chart illustrating the process followed by an observer using an electronic patient monitoring system, in accordance with an embodiment of the present invention.

FIG. 3b is a flow chart illustrating the process followed by an observer using an electronic patient monitoring system with GPS and inter-patient distance monitoring, in accordance with an embodiment of the present invention.

FIG. 4 is a flow chart illustrating the functional operation of an electronic monitoring system, in accordance with an embodiment of the present invention.

FIG. 5 is a top view of a patient identification tag that uses radio frequency (such as Bluetooth or low energy Bluetooth technology), in accordance with an embodiment of the present invention.

FIG. 6 is a top view of an example of a radio frequency (such as Bluetooth or low energy Bluetooth technology) circuit board which can be used for a patient identification tag, in accordance with an embodiment of the present invention.

FIG. 7a is a view of a checkin login screen for an electronic monitoring system, in accordance with an embodiment of the present invention.

FIG. 7b is a view of a patient check-in screen in an electronic monitoring system, in accordance with an embodiment of the present invention.

FIG. 8a is a view of an observer login screen for an electronic monitoring system, in accordance with an embodiment of the present invention.

FIG. 8b is a view of a patient list screen in an electronic monitoring system, in accordance with an embodiment of the present invention.

FIG. 9a is a view of an adminstrator login screen for an electronic monitoring system, in accordance with an embodiment of the present invention.

FIG. 9b is a view of a patient checkup history screen in an electronic monitoring system, in accordance with an embodiment of the present invention.

### DETAILED DESCRIPTION

One or more embodiments of the present invention include (i.e., comprise) a system that uses active radio frequency (RF) identification (RFID) technology to assess completion of visual monitoring of patients in a psychiatric unit of a treatment center or hospital. There are three main components to the visual monitoring system, a patient identification device, an observer transmitter/receiver (T/R) and a centralized software program for data storage, monitoring and retrieval. Together, this system allows for visual observations of patients in an ethically responsible manner, while allowing for increased observation compliance from the current paper checklist system commonly employed. Other embodiments may also include multiple fixed-position T/Rs that are permanently affixed to walls or other structural features of the facility in predetermined positions.

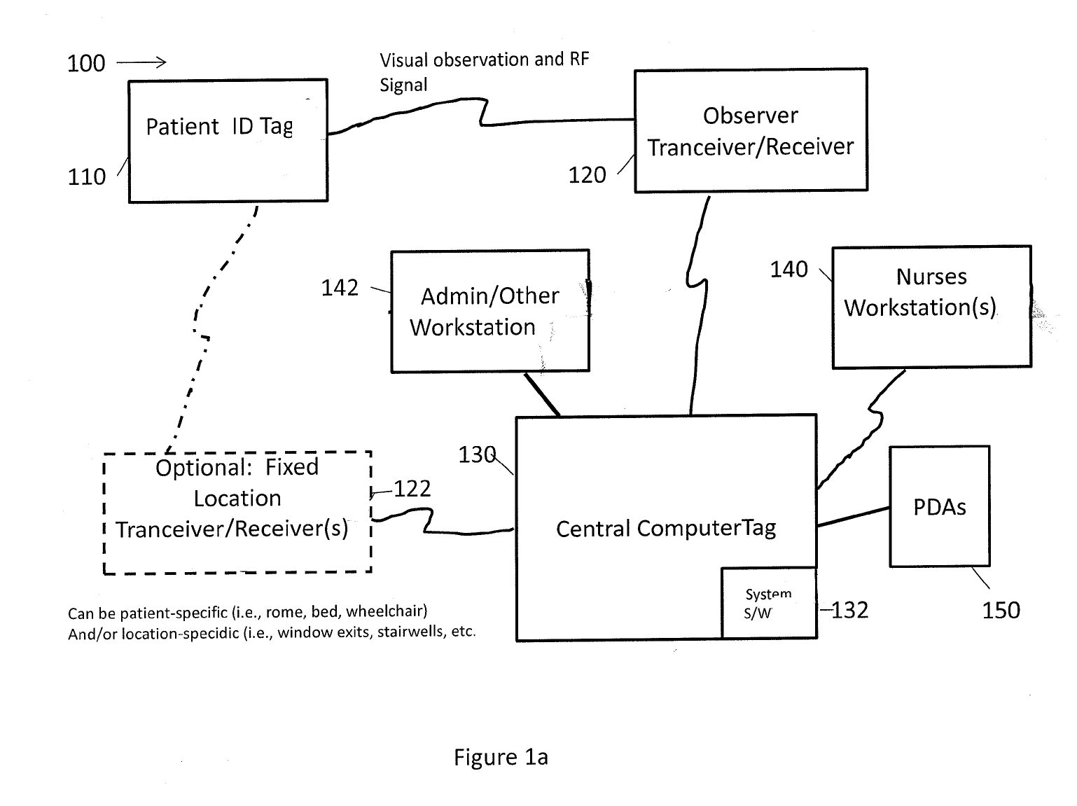

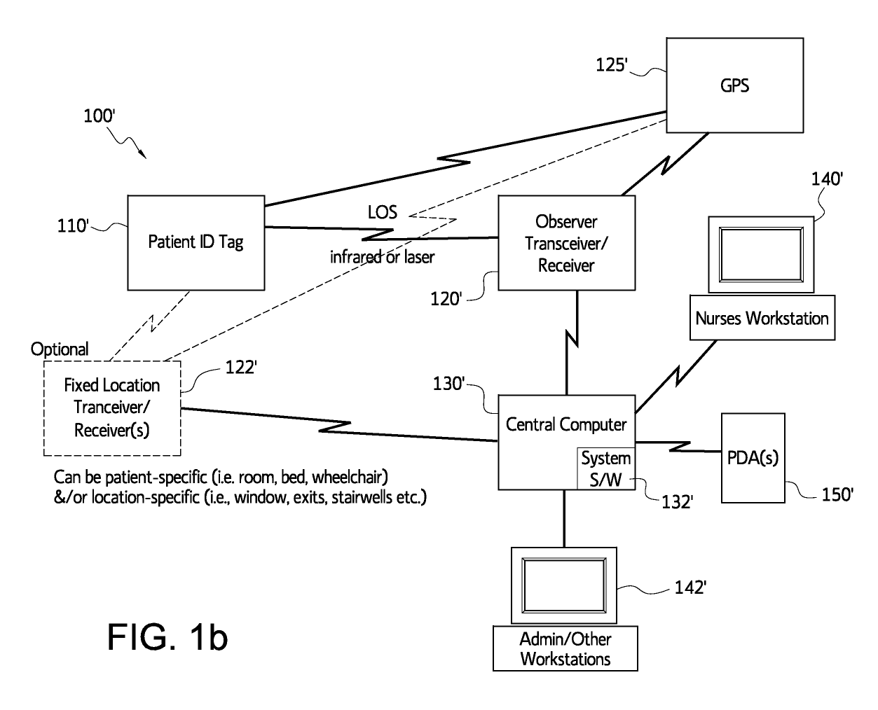

FIG. 1a is a block diagram of an electronic monitoring system using visual observation and RF signals, in accordance with an embodiment of the present invention. In FIG. 1a, an electronic monitoring system 100 is illustrated that includes an active patient identification (ID) tag 110 that is connectible by radio frequency communication during visual observation with a generally mobile observer transceiver/receiver (T/R) 120 which serves as a power source and activates the patient identification tag 110 and is communicatively connected to a central computer system 130 that has an electronic monitoring system software program 132 installed and running The electronic monitoring system 100 may optionally include one or more fixed location T/Rs 122 that is/are also connectible by radio frequency during visual observation to and also serve(s) as a power source to activate the patient identification tag 110. Each fixed location T/R 122 is communicatively connected to the central computer system 130 and the electronic monitoring system software program 132. One or more workstations, for example, one or more nurses workstations 140 and/or one or more administrative/administrator or other workstations 142 may be locally and/or remotely connected to the central computer system 130 and the electronic monitoring system software program 132. In addition, one or more PDA devices 150 may be directly or wirelessly connected to and access the electronic monitoring system software program 132. The software program 132 will take the transmitted data and convert it to a digital display that shows, for example, the patient identification, observation time, patient activity and the personal identification of the staff member who made the visual observation. The digital display can be displayed on the observer's handheld device as well as on the workstation and/or PDA tracking screens. If a scheduled visual observation check is missed, an alarm (visual or by sound, for example) will appear on the screen of the observer and at any workstation and/or PDA, such as a nurse's workstation 140. The system software 132 will also keep a permanent record of all observation histories that can be downloaded to an archival database on a secure hospital server.

Patient Identification System. Using RFID or similar technology (e.g., infra-red, Bluetooth, low-energy Bluetooth, etc.), patient information including name, room number and other relevant information is stored in a passive or an active RFID electronic tag unique to and substantially continuously attached to the patient through one of several means. The tag can be attached to or implanted in a wristband worn by the patient. The tag can be a rigid chip or a flexible circuit board. Flexible circuit boards can be custom designed for the active signal and patient information storage using standard state-of-the-art technology. The tag can also be attached or embedded in a garment or other tag or device worn, attached to or used by the patient. Some of the devices in which the tag can be located can include, but are not limited to, a helmet, a prosthetic device, a brace, a walker, a wheelchair, a necklace, etc.

FIG. 1b is a block diagram of an electronic monitoring system using line of sight and infrared and/or laser, in accordance with an embodiment of the present invention. In FIG. 1b, an electronic monitoring system 100′ is illustrated that includes a patient identification (ID) tag 110′ that is connectible by line-of-sight using infrared and/or laser technology with a generally mobile observer transceiver/receiver (T/R) 120′ which serves as a power source and activates the patient identification tag 110′ and configured to receive and store GPS satellite positioning information from a GPS system 125′. The electronic monitoring system 100′ may optionally include one or more fixed location T/Rs 122′ and also serve(s) as a power source to activate the patient identification tag 110′. The T/Rs 120′, 122′ can also be configured to receive and store GPS satellite positioning information from a GPS system 125′ and are further communicatively connected to a central computer system 130′ that has an electronic monitoring system software program 132′ installed and running One or more workstations, for example, one or more nurses workstations 140′ and/or one or more administrative/administrator or other workstations 142′ may be locally and/or remotely connected to the central computer system 130′ and the electronic monitoring system software program 132′. In addition, one or more PDA devices 150′ may be directly or wirelessly connected to and access the electronic monitoring system software program 132′. The software program 132′ will take the transmitted data and convert it to a digital display that shows, for example, the patient identification, observation time, patient activity and the personal identification of the staff member who made the observation. The digital display can be displayed on the observer's handheld device as well as on the workstation and/or PDA tracking screens. If a scheduled observation period is missed, an alarm (visual or by sound, for example) will appear on the screen of the observer T/R 120′ and at any workstation and/or PDA, such as a nurse's workstation 140′. The system software 132′ will also keep a permanent record of all observation histories that can be downloaded to an archival database on a secure hospital server.

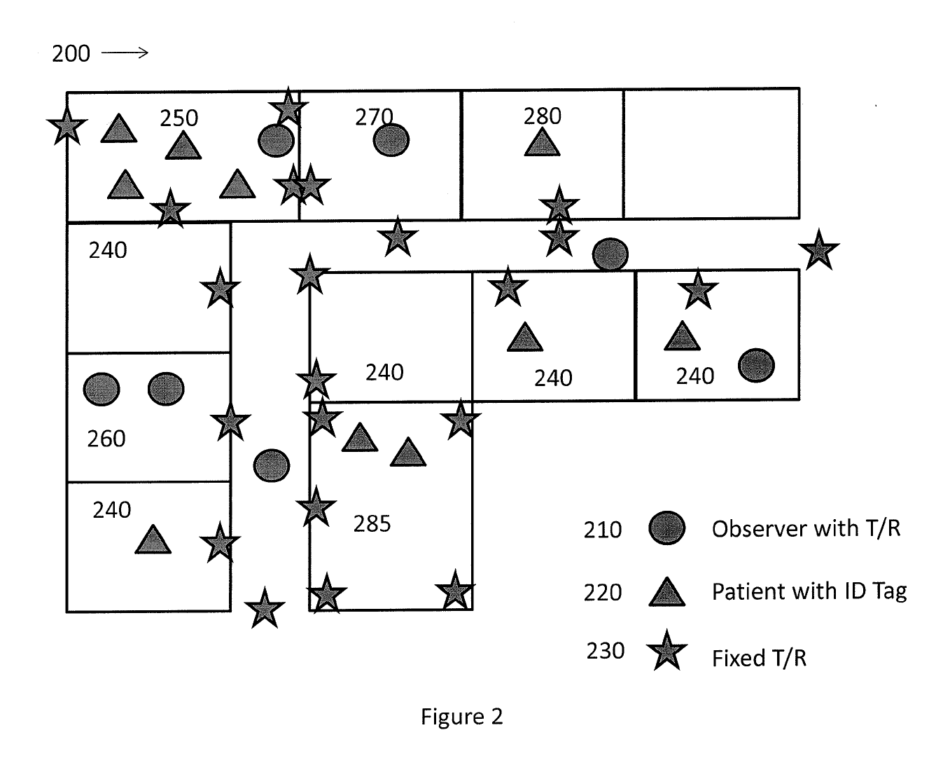

FIG. 2 is a plan view of an exemplary floor plan of a facility in which an electronic monitoring system has been installed, in accordance with one or more embodiments of the present invention. In FIG. 2, a floor plan 200 of a facility is shown to include one or more observers with T/R devices 210, one or more patients with ID tags 220, one or more fixed T/R devices 230, multiple patient rooms 240, a dining area 250, at least one nurses station 260, a kitchen area 270, a laundry area 280, a common room 285, and a hallway 290.

Patient information that can be stored on the patient RFID tag 110, 110′ includes the patient's hospital identification number, name, diagnosis, risk factors, expected pulse rate and/or other physiological signals to monitor, for example, specified levels of activity or rest. In addition, to the specific patient identification information associated with the tag, the system can monitor the patient's location within the facility and/or in relation to other patients and/or observers.

Using radio waves, the patient's identification tag 110, 110′ can be activated and then emit a signal that will be received by a T/R device 120, 120′, which is carried or worn by the observer. The frequency of the radio waves can be in compliance with hospital or institution specifications including HIPAA regulations. The observer responsible for visual patient monitoring at set intervals will carry or wear the T/R device 120, 120′ that activates the patient RFID tag 110, 110′ when the T/R 120, 120′ device is within a given distance from the patient RFID tag 110, 110′ using, for example, Bluetooth or low-energy Bluetooth devices. This distance or range is adjustable via the adjustments to the transmission signal and may be specified by a responsible treatment team at a particular unit or hospital. The distance is controlled so that it is within a visible range of observer to patient. The patient RFID tag 110, 110′ and T/R 120, 120′ will permit visual observations, and/or general observations based on distance. The distance between the observer and the patient could range with the capabilities of the RF system. In a typical example, the range would be less than 100 feet but could be as small as one foot. The distance may be set to different values for different observation situations. For example, during sleeping hours, a close observation, say less than 10 feet, may be appropriate, whereas during waking hours, a greater distance, for example, 10 to 25 feet, could be set. The distance can be set under control of the central computer system. Further, the time interval can be changeably set depending on circumstances such as time of day or changing patient needs. The observer T/R device 120, 120′ may include any personal digital assistant (such as an iPod, nook, iPhone, iTouch, droid, zigbee, etc) or a wrist display or badge display. For patient tracking, the fixed location T/Rs 122, 122′ operate in the same manner as the observer T/Rs with the exception that it is the patient's movement to within a given, predefined distance from the fixed location T/Rs 122, 122′ that causes the fixed location T/Rs 122, 122′ to activate the patient RFID tag 110, 110′.

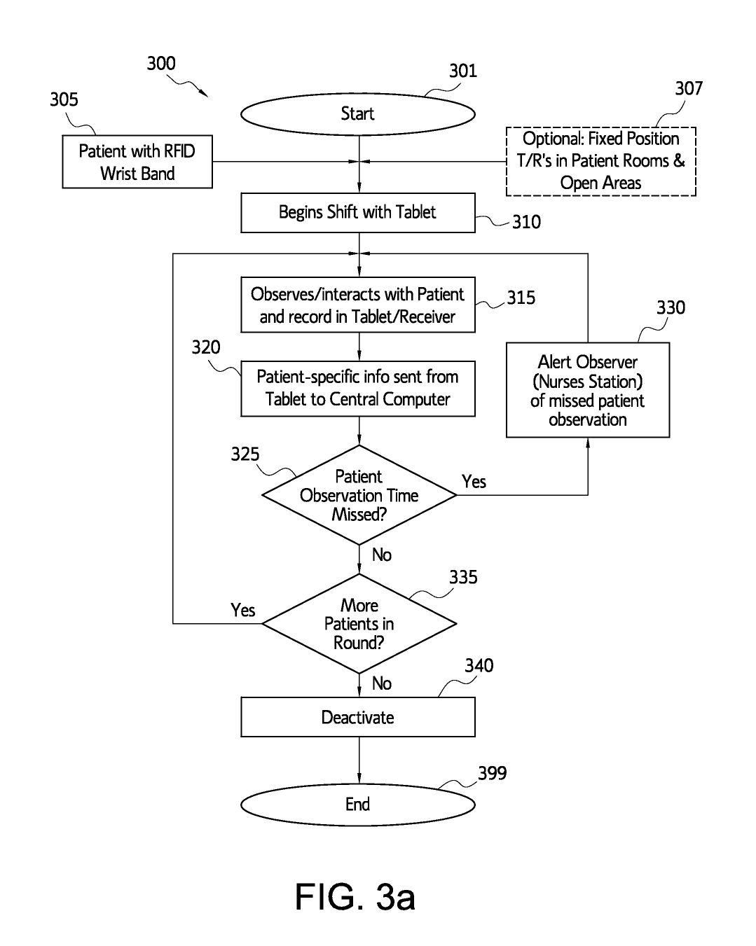

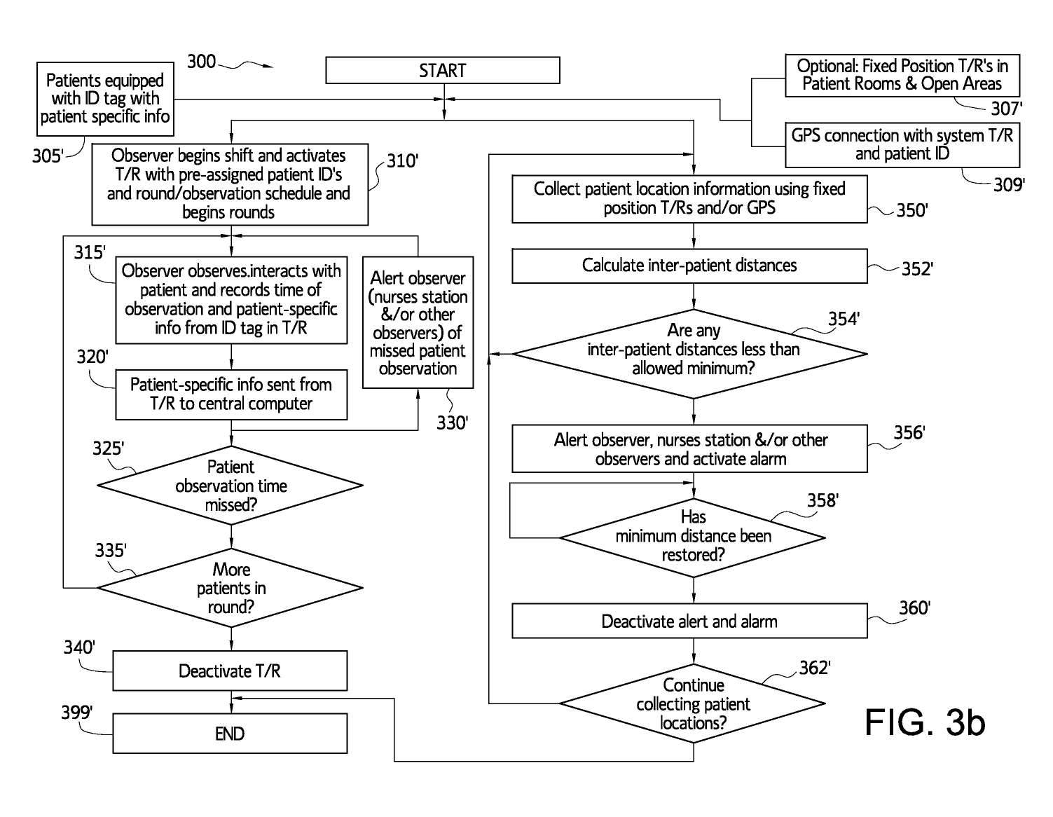

FIG. 3a is a flow chart illustrating the process followed by an observer using an electronic patient monitoring system, in accordance with an embodiment of the present invention. In FIG. 3a, the process is started 301 with an observer beginning their work shift and activating 310 a T/R with pre-assigned patient ID numbers and round/visual observation schedule. Prior to these steps, all patients being monitored by the system are equipped 305 with an ID tag that contains information specific to each patient and, optionally, fixed position T/Rs can be affixed 307 to walls and/or other parts of the facility in various locations in the facility. As the observer observes/interacts 315 with the patients, the information from each patient's ID tag as well as the time of the interaction and other patient-specific information are automatically recorded. After a predefined time period, for example, immediately, every minute, etc., all information recorded by the T/R is sent 320 to the central computer to be processed and stored. For example, the electronic patient monitoring system, which can be implemented in a software program, will take the transmitted data and convert it to a digital display that shows, for example, the patient identification, observation time, patient activity and the personal identification of the staff member who made the observation. The digital display can be displayed on the observer's handheld device as well as on the workstation tracking screen. If a scheduled visual observation check is missed within the given time interval, an alarm (visual or by sound, for example) will appear on the screen of the observer and at any workstation, such as a nurse's station. The software will also keep a permanent record of all observation histories that can be downloaded to an archival database on a secure hospital server. If a missed patient visual observation check is detected 325, an alert is sent 330 to the observer, the nurse's station, other observers, etc. and the observer is directed to locate and observe/interact 315 with the missed patient. If the patient visual observation check was detected 325, then the observer determines 335 whether there are additional patients to be observed. If there are more patients to be observed, the observer is directed to locate and observe/interact 315 with the next patient. If there are no more patients to be observed, the observer is directed to deactivate 340 the T/R and the observation process ends 399.

The RFID tag and T/R devices may be utilized at fixed locations within the unit or facility to monitor patient location, and permit notification via warning light or alarm when patients or staff members are near or have entered areas which have restrictions to access. The RFID tag and observer's T/R device will also function mobily, which is not dependent on a fixed location of service. Once the RFID tag is activated, a signal is sent to the activating fixed location or observer T/R device. The T/R device registers the patient information from the RFID tag in software included in the observer T/R device. This includes an electronic checklist that ensures and documents the signal was received in the given time requirement imposed by the treatment team or facility guidelines.

Software in the T/R device, and at the central nurses' station, gives a warning signal (such as a yellow light or beep), if a patient has not been successfully visually observed within the given time interval specified by the patient's treatment team. This system presents the observer with immediate feedback to go and check on the missed patient. The time interval may be scheduled as continuous (i.e., real-time) monitoring, a predetermined number of minutes (e.g., every 1, 5, 10, 15 or 30 minutes, or increments thereof), hourly monitoring or rounding, monitoring for a predetermined number of hours, or daily monitoring. After the patient has been identified, a note is made in the software and the process is reset to continue with normal monitoring.

In addition to receiving and storing the patient information after the visual observation has been made in the given distance from the patient, the observer T/R device automatically transmits the data wirelessly to a centralized software system. The data can also be incorporated into a more comprehensive electronic medical record.

Centralized Software Monitoring and Warning System. The T/R sends the visual observation patient data to a centralized software system wirelessly and in real time. The software stores the patient identification documentation as collected by the T/R device. Additionally, the centralized software signals an alert (e.g., by light or sound) when a patient observation is missed during a prescribed time interval and generates reports of documented observations.

The centralized software generates an alert of a missed patient observation to, for example, but not limited to, immediately activate any identified camera systems within the assigned proximity of the unit or identified geographical region, activate an emergency response system which may include automatically locking doors permitting outside access, activation of an overhead public announcement system to provide information and alarms, and a visual representation of the location of all identified patients on the unit.

The centralized software can be accessed from a nurses' station in the psychiatric unit, where the nurses' station attendants would also be alerted to any missed visual observation checks. This component to the system adds a secondary check to the observation system in addition to the primary observer responsible for the visual checks. Now, a second nurse or attendant at the nursing station could also be alerted in real time that a patient observation has been missed.

The centralized software can create an alert (by light or sound) when a patient demonstrates a heightened pulse interval, as predetermined based on clinical criteria.

FIG. 3b is a flow chart illustrating the process followed by an observer using an electronic patient monitoring system, in accordance with an embodiment of the present invention. In FIG. 3b, the process is started 301′ with an observer beginning their work shift and activating 310′ a T/R with pre-assigned patient ID numbers and round/visual observation schedule. Prior to these steps, all patients being monitored by the system are equipped 305′ with an ID tag that contains information specific to each patient and, optionally, fixed position T/Rs can be affixed 307′ to walls and/or other parts of the facility in various locations in the facility. The system (i.e., the central computer, T/Rs, and patient ID tags) can also be connected 309′ to and use GPS position information. Alternatively, the system can use Bluetooth or low-energy Bluetooth proximity and patient information that is exchanged between the patient ID tag and the observer T/R. As the observer observes/interacts 315′ with the patients, the information from each patient's ID tag as well as the time of the interaction and other patient-specific information are automatically recorded. After a predefined time period, for example, immediately, every minute, etc., all information recorded by the T/R is sent 320′ to the central computer to be processed and stored. For example, the electronic patient monitoring system, which can be implemented in a software program, will take the transmitted data and convert it to a digital display that shows, for example, the patient identification, observation time, patient activity and the personal identification of the staff member who made the observation. The digital display can be displayed on the observer's handheld device as well as on the workstation tracking screen. If a scheduled observation period is missed, an alarm (visual or by sound, for example) will appear on the screen of the observer and at any workstation, such as a nurse's station. The software will also keep a permanent record of all observation histories that can be downloaded to an archival database on a secure hospital server. If a missed patient observation time is detected 325′, an alert is sent 330′ to the observer, the nurse's station, other observers, etc. and the observer is directed to locate and observe/interact 315′ with the missed patient. If a missed patient observation time was not detected 325′, then the observer determines 335′ whether there are additional patients to be observed. If there are more patients to be observed, the observer is directed to locate and observe/interact 315′ with the next patient. If there are no more patients to be observed, the observer is directed to deactivate 340 the T/R and the observation process ends 399′.

In FIG. 3b, concurrently with and independently from the observer observation process described above, the system can collect patient location information within the facility and determine inter-patient distances to ensure minimum safe patient-to-patient distances are maintained. After the process is started 301′, the system begins to collect 350′ patient location information using the GPS or other positioning/tracking system, Bluetooth, low-energy Bluetooth proximity information, and/or fixed-position T/Rs. Once collected, the system calculates 352′ the inter-patient distances, which can include distances between a patient and every other patient, a patient and only selected other patients, distances between multiple (i.e., 3 or more) patients. This information can also be used to calculate a patient's or group of patients' position relative to restricted areas. After the inter-patient distances are calculated 352′, the system determines 354′ whether any of the distances are less than a pre-defined minimum distance and, if not, the system returns to and continues to collect 350′ patient location information. If so, the system alerts 356′ the patient's observer(s), the nurse's station and/or other observers and activates an alarm. The system then determines 358′ whether the minimum distance has been restored and, if not, continues to determine 358′ whether the minimum distance has been restored. If the minimum distance is determined 358′ to have been restored, then the system deactivates the alarm 360′ and determines 362′ whether to continue to collect patient locations and, if so, returns to and continues to collect 350′ patient location information. If not, the patient location collection process ends 399′.

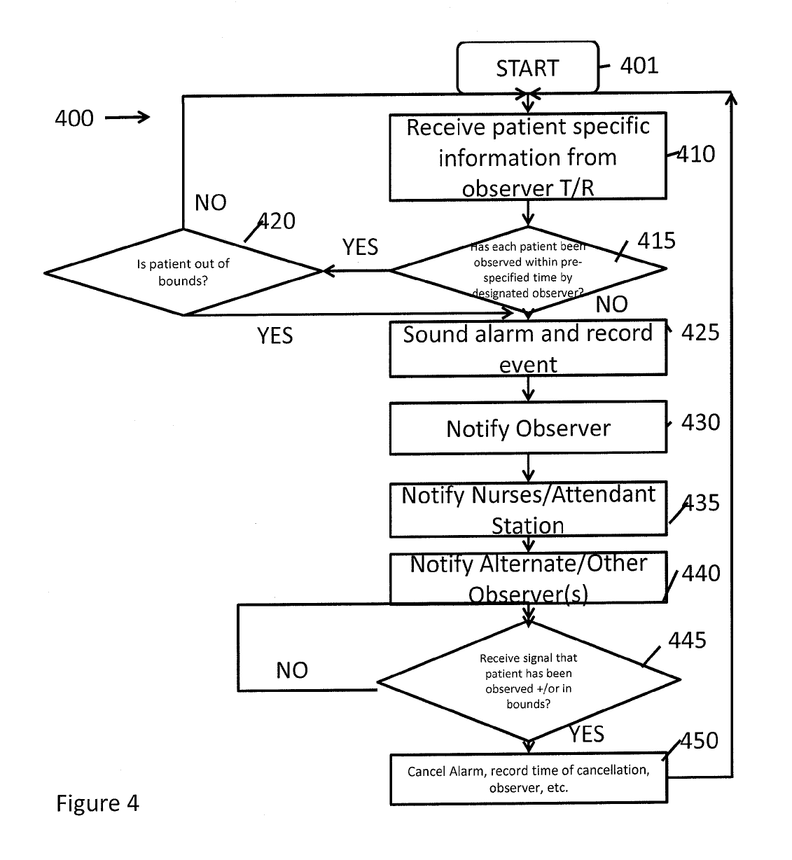

FIG. 4 is a flow chart illustrating the functional operation of an electronic monitoring system, in accordance with an embodiment of the present invention. In FIG. 4, a flow chart 400 illustrating the functional operation of an electronic monitoring system software program is shown. Following start up 401 the program begins receiving 410 patient-specific information from one or more observer T/R devices. This information is used by the program to determine 415 whether all patients have been observed within the pre-specified time interval for each patient. If it is determined 415 that the patient was timely observed, the program determines based on the received patient information whether the patient is “out of bounds,” i.e., not in their approved area of movement, which may vary based on the time of day, and if out of bounds, or if it was determined 415 that the patient was not timely observed, the program sounds 425 an alarm and records the event. If the patient was determined 420 to be “in bounds,” i.e., in their approved area of movement and/or a required distance away from other patients and/or areas, the system returns to receiving 410 patient information. After an alarm is sounded 425, the observer responsible for the patient is notified 430, a nurse's/attendant station is notified 435 and alternate/other observers are also notified 440 of the missed patient observation. On the observer T/R device and nursing workstation (or other workstation) there would be an override which could only be accessed via a password by approved override staff member. The staff member could also code in the reason for override (for example, from a drop down menu). Once a signal has been received 445 to indicate that the patient has either been observed and/or is now in bounds, the alarm is cancelled 450 and associated information with the cancellation (e.g., time of cancellation, ID of the observer that observed the patient, etc.) is recorded, the system returns to receiving 410 regularly scheduled patient observation information.

Further, administrators could also monitor in real time observer compliance to help assess observer quality and to assess perturbations in the process which make it more likely to miss a visual observation, such as a psychiatric counseling session or a medical test. This would allow the ability to fine-tune the observation system to better ensure that a patient is monitored at all prescribed time intervals and to better prevent an adverse event (suicide or self-harming attempt) from occurring.

Hourly Rounding. Hourly rounding will be measured and documented by a RFID tag and T/R device in the same manner as previously described. If transmission is not made during the predetermined time interval a light and/or audible alarm will be sounded by the centralized software area at the nurses' station. Based upon a predetermined line of sight proximity an interaction time measurement will be monitored between caregiver and patient to determine the interaction time between the participants for each hourly rounding event. The centralized software station will document the timeliness of each caregiver as they complete their hourly rounds, as well as the interaction time spent with the patient within a predetermined line of sight proximity. Interaction time indirectly provides information to better assist quality indicators of interaction directly relating to patient care and satisfaction.

Prevention of harm/inappropriate behavior. A measurement of patient-to-patient proximity can be obtained by for example, GPS coordinates or an active transmitter on each patient, for example, a Bluetooth or low-energy Bluetooth device, that will signal when a given distance would be achieved to ensure that an appropriate distance between patients is maintained. Based on a predetermined acceptable distance of identified patients, hour of the day, or unit location patients determined to be at risk will trigger notification of the central software system via green, yellow or red light or audible alarm when identified patients are within a predetermined proximity as measured by RFID tag transmission.

FIG. 5 is a top view of a patient identification tag that uses low energy Bluetooth technology, in accordance with an embodiment of the present invention. In FIG. 5, a patient identification tag 500 includes a body portion 510 that is attached to a strap portion 520, which has multiple openings 522 defined in the strap portion 520. The body portion 510 includes a Bluetooth low energy (BLE) RFID device 530 that can transmit a signal having a 360° range of about 10 to 20 feet from the device. A battery holder 540 is also attached to the body portion 510 and is configured to receive and hold a flat battery (not shown) and is electrically connected to the BLE RFID device 530. The body portion 510 also includes a top flange 512 on which are located a pin 514 that is positioned and configured to fit within the openings 522 on the strap portion 520. An opening 516 is formed in the top flange 512 adjacent the pin 514 and has a grommet 517 securely fastened within the opening 516 and the grommet 517 is configured to fit onto and securely hold the pin 514 after the identification tag 500 has been placed around a patient's wrist and one of the opening 522 on the strap 520 have been fitted over the pin 514.

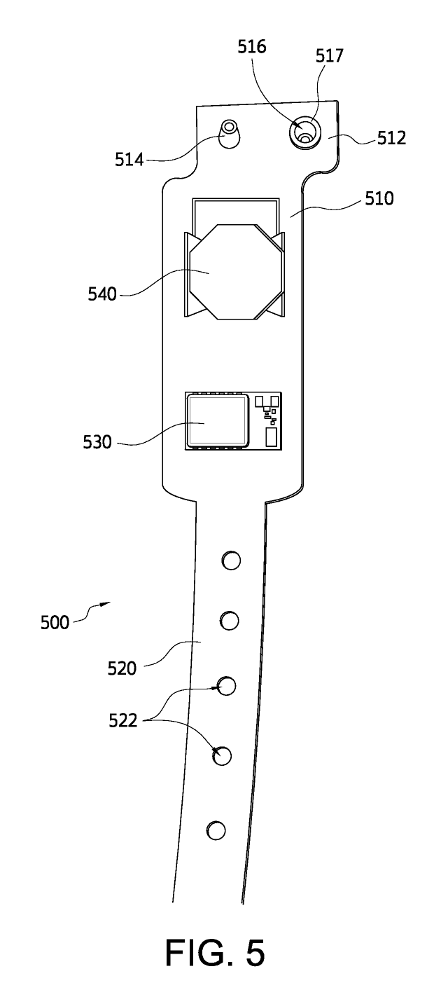

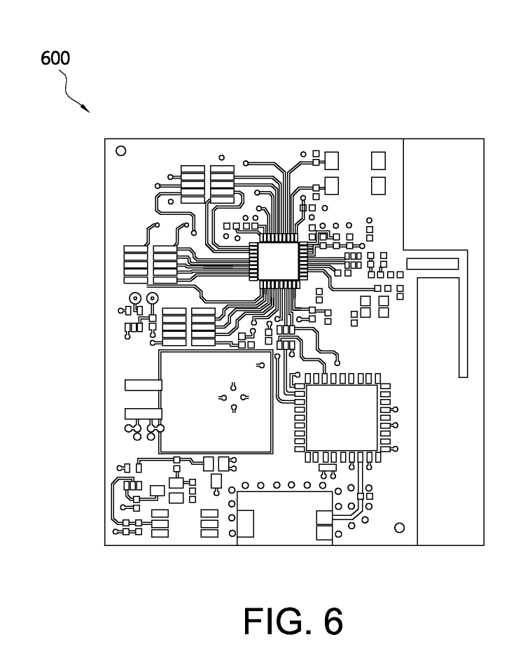

FIG. 6 is a top view of a flexible Bluetooth low energy circuit board for use in a patient identification tag, in accordance with an embodiment of the present invention. In FIG. 6, an example of a flexible active circuit board 600 that includes the transmission components and patient identification data is illustrated.

FIG. 7a is a view of a check-in login screen for a user device in an electronic monitoring system, in accordance with an embodiment of the present invention. In FIG. 7a, a screen 700 is displaying a login screen that includes a username entry box 710 and password entry box 720, a login selection button 730, a return icon 702, a movement icon 704 and a page change icon 706. The username entry box 710 is configured to receive a check-in user name and the password entry box 720 is configured to receive a check-in password associated with the check-in user name and the login selection button 730 is configured to be selected after the user name and password have been entered and to pass control to the program to determine whether the correct user name and password combination were entered and to determine what information and user rights are associated with the user name and password and them display that information on the screen, for example, as shown in FIG. 7b. When selected, the return icon 702 displays the prior screen information, the movement icon 704 permits a user to scroll up and down depending on the amount of information on each page and the current position in the information on the page, and, if more than one page of patient information is associated with the patient, the page change icon 706 permits a user to move forward and backward through the pages.

FIG. 7b is a view of a patient check-in screen in an electronic monitoring system, in accordance with an embodiment of the present invention. In FIG. 7b, a patient check-in screen 700′ is shown to include a picture of a patient 710′, an add picture button 715′, a first name input box 720′, a last name input box 730′, a check-up interval input box 740′, a room number input box 750′, a patient ID input box 760′, a device ID input box 770′, a scan device barcode selection button 780′, an add patient selection button 790′, the return icon 702, the movement icon 704 and the page change icon 706. When the add picture button 715′ is selected a picture of the patient may be added by, for example, but not limited to, taking a picture with a camera that is part of, connected to or associated with the user device, downloading the picture from a storage device that is connected to the user device, etc. When the scan device barcode selection button 780′ is manually selected, the user device will scan the barcode associated with the patient's identification tag. Alternatively, in embodiments of the invention that use the BLE RFID tags, selecting the scan device barcode selection button 780′would cause the user device to read the RFID device number associated with the patient's ID tag. Still further, the user device could automatically detect a signal from and read the RFID device number associated with the patient's ID tag when the user device comes within the transmit range of the RFID device.

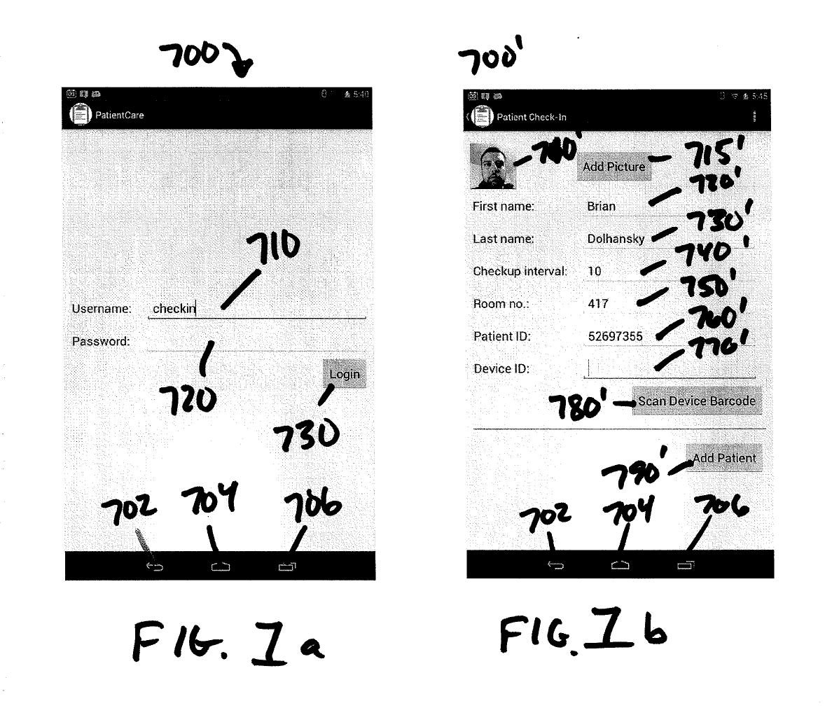

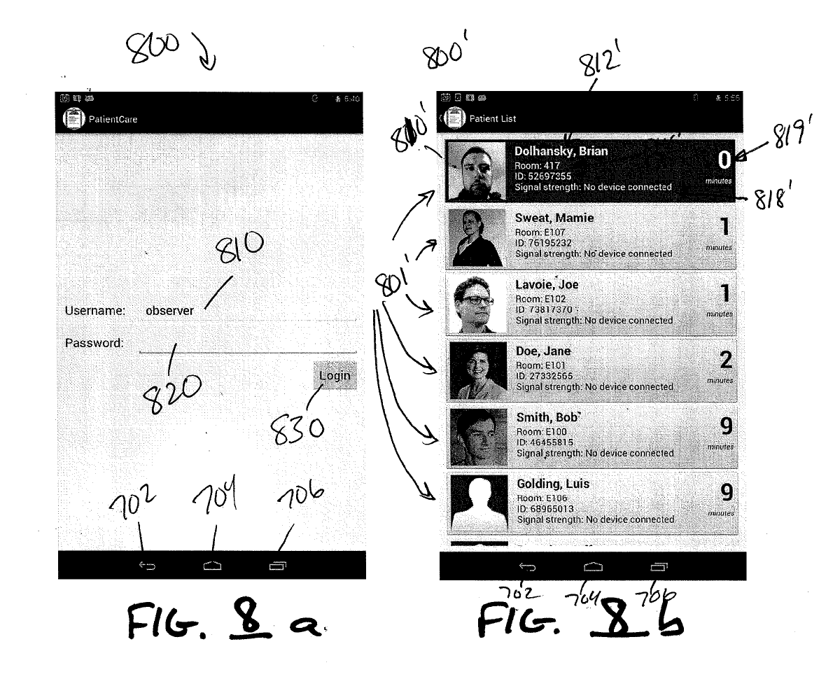

FIG. 8a is a view of an observer login screen for a user device in an electronic monitoring system, in accordance with an embodiment of the present invention. In FIG. 8a, a screen 800 is displaying a login screen that includes an observer's username entry box 810 and password entry box 820, a login selection button 830, a return icon 802, a movement icon 804 and a page change icon 806. The username entry box 810 is configured to receive an observer's user name and the password entry box 820 is configured to receive an observer password associated with the observer's user name and the login selection button 830 is configured to be selected after the observer's user name and password have been entered and to pass control to the program to determine whether the correct observer's user name and password combination were entered and to determine what information and user rights are associated with the observer's user name and password and them display that information on the screen, for example, as shown in FIG. 8b. When selected, the return icon 802 displays the prior screen information, the movement icon 804 permits a user to scroll up and down depending on the amount of information on each page and the current position in the information on the page, and, if more than one page of patient information is associated with the patient, the page change icon 806 permits a user to move forward and backward through the pages.

FIG. 8b is a view of a patient list screen in an electronic monitoring system, in accordance with an embodiment of the present invention. In FIG. 8b, a patient list screen 800′ is shown to include multiple patient information summaries 801′ that each display a picture or generic silhouette of a patient 810′, a last and first name of the patient 812′, a room number 814′, a last name input box 816′, a signal strength indication 818′, a time remaining to observe 819′, the return icon 702, the movement icon 704 and the page change icon 706. When the observer comes within range of each patient's RFID tag, the device automatically detects the signal and reads the RFID device number associated with the patient's ID tag as well as any other pertinent patient data, for example, vital statistics, actual location, activity, etc. As seen in FIG. 8b, the first patient information summary 801′ for “Dolhansky, Brian” is highlighted to indicate that the required observation time has passed (note the 0 minutes value displayed for the time remaining to observe 819′) and that no actual observation of the patient has been recorded.

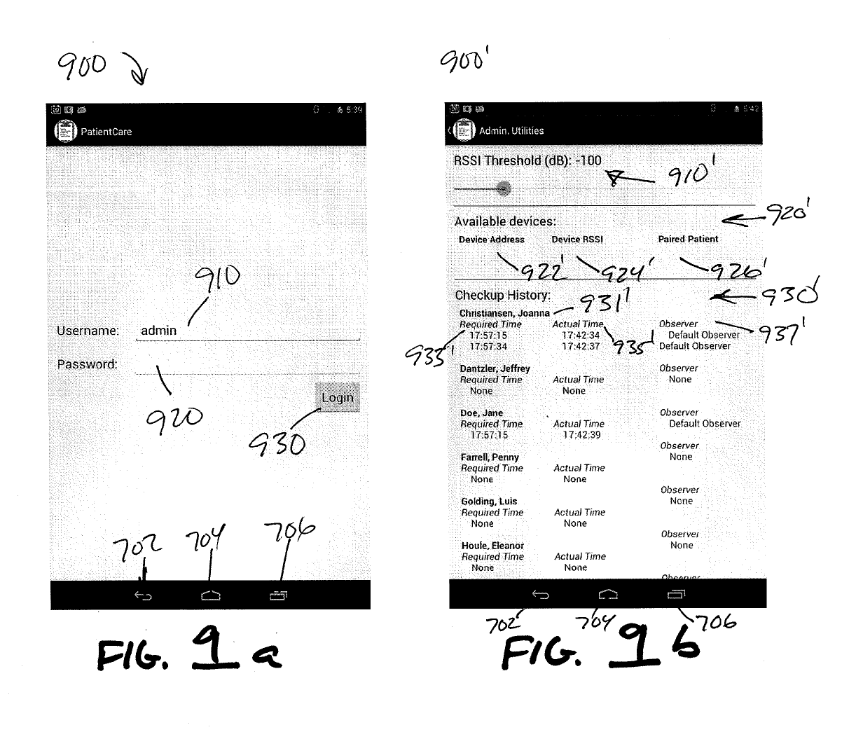

FIG. 9a is a view of an administrator login screen for a user device in an electronic monitoring system, in accordance with an embodiment of the present invention. In FIG. 9a, a screen 900 is displaying a login screen that includes an administrator's username entry box 910 and password entry box 920, a login selection button 930, a return icon 902, a movement icon 904 and a page change icon 906. The username entry box 910 is configured to receive an administrator's user name and the password entry box 920 is configured to receive an administrator password associated with the administrator's user name and the login selection button 930 is configured to be selected after the administrator's user name and password have been entered and to pass control to the program to determine whether the correct administrator's user name and password combination were entered and to determine what information and user rights are associated with the administrator's user name and password and them display that information on the screen, for example, as shown in FIG. 9b. When selected, the return icon 902 displays the prior screen information, the movement icon 904 permits a user to scroll up and down depending on the amount of information on each page and the current position in the information on the page, and, if more than one page of patient information is associated with the patient, the page change icon 906 permits a user to move forward and backward through the pages.

FIG. 9b is a view of a patient checkup history screen in an electronic monitoring system, in accordance with an embodiment of the present invention. In FIG. 9b, an administrative utilities screen 900′ is shown to include a received signal strength indication (RSSI) Threshold value 910′, a listing of available devices section 920′ with information for each device including a device address 922′, a device RSSI 924′ and a paired patient name 926′, and a patient checkup history section 930′ with separate information for each patient that includes a required patient observation time 933′, an actual patient observation time 935′ and an assigned observer name for the patient 937′.

As will be appreciated from the foregoing description the present invention provides an electronic patient monitoring system that includes a not easily removable patient identification and monitoring device, an observer transmitter/receiver device to communicate with the not easily removable patient identification and monitoring device when within a specified visual range of each other, and a central computer system including, at least, a computer processor, communications components and system software to communicate with the observer transmitter/receiver device at specified/predetermined time intervals to receive observer- and patient-specific information.

The invention having been described in certain embodiments, it will be apparent to those skilled in the art that many changes and alterations can be made without departing from the spirit of the invention. Accordingly, Applicants intend to embrace all such alternatives, modifications, equivalents and variations in keeping therewith.

What is claimed is:

1. A system comprising:
a central computer configured to store and execute program code to monitor and track observations of patients within an observer's predetermined proximity to patient within a determined time interval;
an observer transmitter/receiver (T/R) module configured to be attached to or carried by the observer and to communicate with the central computer;
an identification device configured to be attached to the patient and to communicate at least a proximity of the identification device and can include patient information to the observer T/R; and
at least one workstation configured to communicate with the central computer to receive information on the proximity of each patient to the observer T/R and observation check within the predetermined time interval.

2. The system of claim 1 further comprising:
at least one fixed location T/R module configured to receive proximity information from the identification device attached to the patient and to communicate at least the patient proximity information to the central computer.

3. The system of claim 2 wherein the at least one observer T/R module is further configured to communicate with the central computer at a predetermined time interval.

4. The system of claim 2 wherein the patient identification device, the at least one fixed location T/R module and the observer T/R module are configured to receive location information from a positioning system and to communicate the location information to the central computer.

5. The system of claim 2 wherein the patient identification device, at least one fixed location T/R module and the observer T/R module each include a Bluetooth or Bluetooth low-energy radio frequency identification (RFID) tag configured to transmit and receive the proximity information and to communicate at least the patient proximity information to the central computer.

6. The system of claim 2 wherein the patient identification device, the at least one fixed location T/R module and the observer T/R module each include a radio frequency identification (RFID) tag configured to transmit and receive the patient proximity information and to communicate at least the patient proximity information to the central computer.

7. The system of claim 1 wherein the identification device and the observer T/R are communicatively connected to a positioning system and configured to receive information on their respective locations at a given time.

8. The system of claim 2 wherein the identification device, the observer T/R and the at least one fixed location T/R module are communicatively connected to a positioning system and configured to receive information on their respective locations at a given time.

9. The system of claim 1 further comprising:
at least one electronic data device communicatively connected to the central computer and configured to receive patient observation information.

10. A computer-implemented method comprising:
a. activating a tablet with an active Bluetooth or Bluetooth low-energy transmitter/receiver (T/R) and receiving in the tablet a listing of pre-assigned patients and a patient observation time schedule;
b. observing one of the pre-assigned patients and receiving in the tablet patient-specific information from an active Bluetooth or Bluetooth low-energy transmitter associated with the observed patient;
c. sending the received patient-specific information from the tablet to a central computer including a time of observation of the one of the pre-assigned patients;
d. determining whether any observation times in the schedule have been missed for any of the pre-assigned patients and, if so, sending alerts to at least a responsible observer and a nurses' workstation and logging the missed observation for each determined missed observation;
e. determining whether there are more patients to be observed in the listing of pre-assigned patients and, if so, repeating steps b, c and d; and
f. deactivating the tablet.

11. The computer-implemented method of claim 10 wherein the activating a tablet includes communicatively connecting the tablet to the central computer upon receiving a valid user name and password.

12. The computer-implemented method of claim 10 wherein the observing one of the pre-assigned patients includes moving the tablet within a predetermined distance of the one of the pre-assigned patients and receiving the patient-specific information for the one of the pre-assigned patients from an active Bluetooth or Bluetooth low-energy transmitter associated with the observed patient.

13. The computer-implemented method of claim 12 wherein the receiving the patient-specific information for the one of the pre-assigned patients includes receiving a time of the observation, a status of the one of the pre-assigned patients, and a name of an observer making the observation.

14. The computer-implemented method of claim 10 further comprising:
sending the received patient-specific information from the central computer to at least one of the nurses' workstation, an administrative workstation, and an electronic handheld information device.

15. A computer-implemented method comprising:
a. activating a tablet with an active Bluetooth or Bluetooth low-energy transmitter/receiver (T/R) and receiving in the tablet a listing of pre-assigned patients and a patient observation time schedule;
b. observing one of the pre-assigned patients and receiving in the tablet patient-specific information from an active Bluetooth or Bluetooth low-energy transmitter associated with the observed patient;
c. sending the received patient-specific information from the tablet to a central computer including a time of observation of the one of the pre-assigned patients;
d. determining whether any observation times in the schedule have been missed for any of the pre-assigned patients and, if so, sending alerts to the observer, at least a responsible observer and a nurses' workstation and logging the missed observation for each determined missed observation;
e. collecting in the central computer patient location information from at least one fixed position T/R or a positioning system;
f. calculating in the central computer inter-patient distances based on the patient location information;
g. determining in the central computer whether any of the calculated inter-patient distances are less than a predetermined allowed minimum distance and, if any of the calculated inter-patient distances are less than a predetermined allowed minimum distance, sending an alert to an observer tablet and a nurses' workstation;
h. determining in the central computer whether the predetermined allowed minimum inter-patient distance has been restored and, if the predetermined allowed minimum inter-patient distance has been restored, deactivating the alarm;
i. determining in the central computer whether to continue collecting in the central computer patient location information from the at least one fixed position T/R or the positioning system and, if it is determined to continue collecting the information, repeating steps e-i;
j. determining whether there are more patients to be observed in the listing of pre-assigned patients and, if there are more patients to be observed, repeating steps b-d; and
k. deactivating the tablet.

16. The computer-implemented method of claim 15 wherein the activating a tablet includes communicatively connecting the tablet to the central computer upon receiving a valid user name and password.

17. The computer-implemented method of claim 15 wherein the observing one of the pre-assigned patients includes moving the tablet within a predetermined distance of the one of the pre-assigned patients and receiving the patient-specific information for the one of the pre-assigned patients from an active Bluetooth or Bluetooth low-energy transmitter associated with the observed patient.

18. The computer-implemented method of claim 17 wherein the receiving the patient-specific information for the one of the pre-assigned patients includes receiving a time of the observation, a status of the one of the pre-assigned patients, and a name of an observer making the observation.

19. The computer-implemented method of claim 18 wherein the receiving the status of the one of the pre-assigned patients comprises receiving information on whether an observation of the patient was made, information on the behavior of the patient, and information on the patient's safety.

20. The computer-implemented method of claim 15 further comprising:
sending the received patient-specific information from the central computer to at least one of the nurses' workstations, an administrative workstation, and an electronic handheld information device.

21. The computer-implemented method of claim 15 wherein the patient-specific information is further sent to a comprehensive electronic medical records system.
